(19) United States
(12) Patent Application Publication
(10) Pub. No.: US 2016/0163222 A1
(43) Pub. Date: Jun. 9, 2016

(54) WORKSITE SIMULATION AND OPTIMIZATION TOOL

(71) Applicant: Caterpillar Inc., Peoria, IL (US)

(72) Inventors: Christopher Michael SPROCK, Peoria, IL (US); Praveen HALEPATALI, Savoy, IL (US); Shuang WU, Champaign, IL (US); Zhehui ZHONG, Ontario (CA); Yongtao LI, Savoy, IL (US); Ryan Steven BAUMANN, Peoria, IL (US); Rachel Barbara PRICE, Peoria, IL (US)

(73) Assignee: Caterpillar Inc., Peoria, IL (US)

(21) Appl. No.: 14/563,195

(22) Filed: Dec. 8, 2014

(51) Int. Cl. G09B 19/00

(52) U.S. Cl. CPC G09B 19/00

(57) ABSTRACT

A system, method, and non-transitory computer-readable storage medium for worksite simulation and optimization is disclosed. The method may include obtaining measured data for a plurality of worksite processes on the worksite. The method may further include performing a statistical analysis of the measured data and outputting a statistical distribution of the measured data. The method may further include obtaining machine design performance information for a plurality of machines involved in the plurality of worksite processes. The method may further include obtaining site layout information for the worksite. The method may further include generating a model for operation of the worksite based on the statistical distribution of the measured data, the machine design performance information, and the site layout information.

### TECHNICAL FIELD

The present disclosure relates generally to a system for a worksite and more particularly, to techniques for simulating and optimizing worksite processes.

### BACKGROUND

A worksite, such as a mining site or a quarry, has several operating systems that work in a dependent manner to provide a desired output. For example, in a mining or quarry site, there may be sites where rocks are mined, loaded onto trucks, and delivered to crushers that are in a different location from the loading/mining site. The crushers may crush the rocks and after further processing, the crushed rock may be dispatched from the worksite as the output of the worksite. Site engineers are frequently interested in optimizing the worksite output. For example, site engineers may be interested in increasing the site production, which may be defined as the amount of material (e.g., crushed rock) produced per hour. In order to increase the site production, site engineers may need to determine which portion of the entire process from mining to crushing to further processing has any bottlenecks and which, if any, process parameters can be improved to increase the site production.

However, a worksite has hundreds if not thousands of interdependent processes that work in conjunction to produce the desired output. Knowing which process or processes to improve may be difficult to do manually and may not provide the desired optimization. For example, it may be difficult to determine manually whether adding an extra haul route will improve production by 10% or 1% or 0.1%. It may be difficult to determine manually that the real bottleneck is the crushing rate and is resulting in a large queue at the crusher due to which the trucks are unable to get back to the loading site.

An exemplary conventional simulation technique is disclosed in U.S. Patent Publication No. 2013/0311153 (the '153 publication) by Moughler et al. published on Nov. 21, 2013. The '153 publication sorts among a plurality of a potential route plans for operating an autonomous ground based machine.

Although the process of the '153 publication may allow validation of proposed lanes and roads on a worksite prior to their actual construction, the '153 publication does not describe techniques that allow optimization of a worksite output by considering several processes that currently exist on a worksite, such as the average load times, haul routes, machine performance curves, etc.

The disclosed worksite simulation and optimization tool is directed to overcoming one or more of the problems set forth above and/or other problems of the prior art.

### SUMMARY

In one aspect, the present disclosure is directed to worksite simulation and optimization tool. The tool may include one or more memories storing instructions and a controller configured to execute the instructions to perform operations including obtaining measured data for a plurality of worksite processes on the worksite. The operations may further include performing a statistical analysis of the measured data and outputting a statistical distribution of the measured data. The operations may further include obtaining machine design performance information for a plurality of machines involved in the plurality of worksite processes. The operations may further include obtaining site layout information for the worksite. The operations may further include generating a model for operation of the worksite based on the statistical distribution of the measured data, the machine design performance information, and the site layout information.

In another aspect, the present disclosure is directed to a computer-implemented method for worksite simulation and optimization. The method may include obtaining measured data for a plurality of worksite processes on the worksite. The method may further include performing a statistical analysis of the measured data and outputting a statistical distribution of the measured data. The method may further include obtaining machine design performance information for a plurality of machines involved in the plurality of worksite processes. The method may further include obtaining site layout information for the worksite. The method may further include generating a model for operation of the worksite based on the statistical distribution of the measured data, the machine design performance information, and the site layout information.

In yet another aspect, the present disclosure is directed to a non-transitory computer-readable storage medium storing instructions that enable a computer to implement a method for worksite simulation and optimization. The method may include obtaining measured data for a plurality of worksite processes on the worksite. The method may further include performing a statistical analysis of the measured data and outputting a statistical distribution of the measured data. The method may further include obtaining machine design performance information for a plurality of machines involved in the plurality of worksite processes. The method may further include obtaining site layout information for the worksite. The method may further include generating a model for operation of the worksite based on the statistical distribution of the measured data, the machine design performance information, and the site layout information.

### BRIEF DESCRIPTION OF THE DRAWINGS

The patent or application file contains at least one drawing executed in color. Copies of this patent or patent application publication with color drawing(s) will be provided by the Office upon request and payment of the necessary fee.

FIG. 1 illustrates an exemplary disclosed worksite simulation and optimization tool;

FIG. 2 is a flowchart depicting an exemplary disclosed method that may be performed by the worksite simulation and optimization tool of FIG. 1; and

FIGS. 3, 4, 5, and 6 illustrate examples of measured data and simulation data used for worksite simulation and optimization.

### DETAILED DESCRIPTION

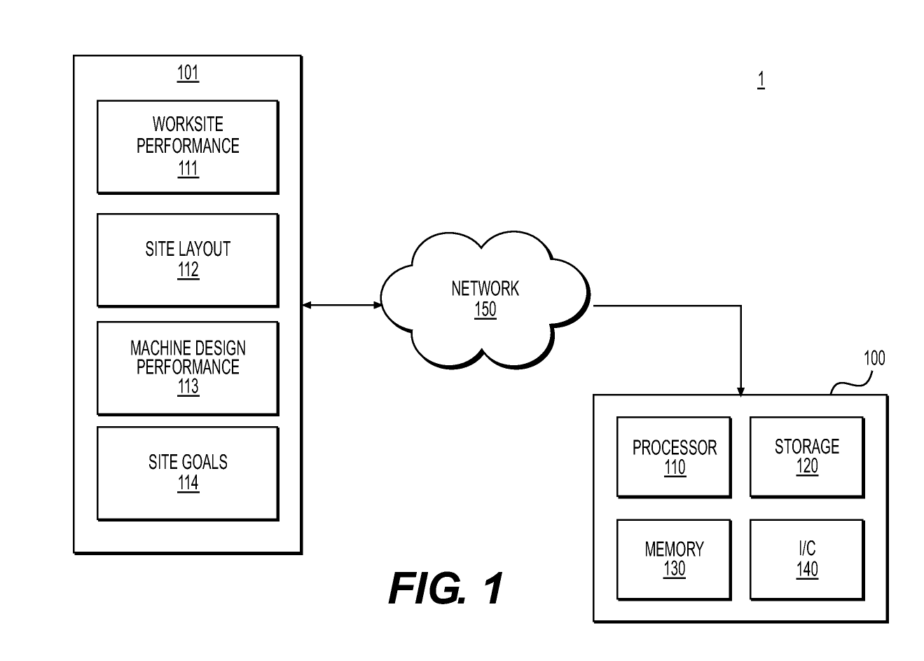

FIG. 1 illustrates an exemplary worksite simulation and optimization tool 1 (also referred to herein as “simulation tool 1”). Simulation tool 1 may simulate various processes executing on a worksite such as a mine site or any other type of worksite traversable by various machines (not shown). The machines may include a mobile machine that performs one or more operations associated with an industry, such as mining, construction, farming, transportation, or any other industry. For example, the machines may be a load-moving machine, such as a haul truck, a loader, an excavator, or a scraper. The machines may be manually controlled, semi-autonomously controlled, or fully-autonomously controlled.

Simulation tool 1 may include a controller 100 and worksite information 101 communicably connected by a network 150. Controller 100 may include a processor 110, storage 120, memory 130, I/O 140, and any other components for running an application. Processor 110 may include one or more known processing devices, such as a microprocessor. Storage 120 may include a volatile or non-volatile, magnetic, semiconductor, tape, optical, removable, nonremovable, or other type of storage device or computer-readable medium. Storage 120 may store programs and/or other information, operational data retrieved from one or more databases storing worksite information 101, and any other information that may be used by controller 100, as discussed in greater detail below. Memory 130 may include one or more storage devices configured to store information used by controller 100 to perform certain functions related to the disclosed embodiments.

I/O 140 may include I/O ports 140 that send and/or receive data from one or more devices or systems. For example, I/O ports 140 may include ports that enable controller 100 to receive data from one or more user devices such as a keyboard, mouse, touchscreen, etc. Likewise, I/O ports 140 may include ports that enable controller 100 to send data to display information, such as simulation output information, one or more graphical user interfaces, etc., on a display device. I/O ports 140 may also include any other type of data port that enables controller 100 to communicate with other systems, such as to retrieve data from one or more databases storing worksite information 101.

Network 150 may include any one of or combination of wired or wireless networks. For example, network 150 may include wired networks such as twisted pair wire, coaxial cable, optical fiber, and/or a digital network. Likewise, network 150 may include any wireless networks such as RFID, microwave or cellular networks or wireless networks employing, e.g., IEEE 802.11 or Bluetooth protocols. Additionally, network 150 may be integrated into any local area network, wide area network, campus area network, or the Internet.

Worksite information 101 may include both dynamic and static information regarding various processes on the worksite. Worksite information 101 may be stored on one or more databases (not shown) and may be collected from the different machines operating on the worksite. Dynamic information may be information, which is not reasonably constant, such as the load times for the different haul trucks or the crushing times for the different crushers. Static information may be information that is reasonably constant, such as the location of different crushers, dump zones, machine power curve (e.g., given a certain payload or grade, how fast is a given machine predicted to move).

To further explain worksite information 101 and the exemplary embodiments herein, consider a quarry site where rocks are mined at various mining locations and loaded by loaders onto haul trucks, which haul the rocks to a crushing site and dump the rocks, which are then crushed and stockpiled by one or more crushers. The haul trucks return to the loaders after dumping the rocks into the crushers. The crushed rock stockpiles are then loaded on to highway trucks. Several routes exist on the worksite between the mining, loading, and crushing locations. Each of these routes has one or more speed limits. Several machines operate on these routes.

For the above exemplary worksite, worksite information 101 may be broadly divided into four categories of information—worksite performance 111, site layout 112, machine design performance 113, and site goals 114. Worksite performance 111 (also referred to herein as “worksite performance information 111”) may include dynamic information such as the amount of rock (in Ton/hour) loaded by the loaders, the amount of rock (in Ton/hour) crushed by the crushers, and the amount of rock (in Ton/hour) loaded onto the highway trucks. The following are some additional non-limiting examples of worksite performance information 111:

(a) load time—may be defined as the time it takes for a single haul truck to be loaded once the haul truck pulls upto a given loader;
(b) haul time—may be defined as the time it takes for a single haul truck to travel from the loader to the crusher after being loaded;
(c) dump time—may be defined as the time it takes for a single haul truck from lining up at a crusher to dumping the rocks into the crusher;
(d) return time—may be defined as the time it takes for a single haul truck to return to a loader after dumping the rocks into the crusher;
(e) truck utilization—may be defined as the percentage of total calendar time a single haul truck is working, idle with the engine turned on, or idle with the engine turned off;
(f) loader utilization—may be defined as the percentage of total calendar time a single loader is working or idle;
(g) fuel consumption—may be defined as the amount of fuel burnt for a single haul truck during a single load-haul-dump-return cycle;
(h) payload—may be defined as total amount of rock (in Ton/hour) loaded onto the highway trucks;
(i) worksite production—may be defined as amount of rock loaded on the highway trucks/hour and hauled away from the worksite; etc.

Site layout 112 (also referred to herein as “site layout information 112”) may include information on the layout of the worksite such as the number of pits, number of crushers, number of loaders, worksite topography, number of haul routes, etc. Machine design performance 113 (also referred to herein as “machine design performance information 113”) may include information regarding the performance characteristics of the different machines operating on the worksite. For example, performance characteristics may include a machine load curve, machine power curve, machine capacity in terms or weight, body capacity in terms of volume, dumping time, etc. Site goals 114 may include the desired parameters to be optimized such as cost of production, productivity, etc.

Using the worksite information 101, controller 100 (and more particularly, processor 110) may prepare a model describing the operations of the worksite. For example, controller 110 may prepare a model that simulates worksite production (e.g., amount of rock loaded on the highway trucks/hour and hauled away from the worksite) as a function of load time, dump time, haul time, return time, number of haul routes, worksite topography, number of loaders, number of crushers, number of pits, haul route speed limits, etc. If a model can predict, within a given tolerance, the worksite production, a site engineer can determine which of the above parameters can be improved if one of the site goals is to improve worksite production. In an exemplary embodiment, given a site goal 114 of increased productivity, controller 100 could iteratively modify the different parameters describing the model to determine the necessary changes required for increased productivity.

To generate the model, controller 100 may obtain measured data for worksite performance information 111 and obtain a statistical distribution of the measured data. For example, controller 100 may take several (e.g., a thousand) samples of load times measured across the worksite and determine a statistical distribution describing the load times. Similarly, controller 100 may take samples of load, haul, dump, and return times measured across the worksite and determine a statistical distribution describing them. Controller 100 may then take samples of the measured worksite production and determine its statistical distribution. Controller 100 may then create a model by using a statistical technique to describe the worksite production as a function of load time, dump time, haul time, return time, number of haul routes, worksite topography, number of loaders, number of crushers, number of pits, haul route speed limits, etc. The statistical technique may be any parametric fitting technique that fits the measured data such that a dependent variable (e.g., worksite production) is described as a function of other independent variables (load time, dump time, haul time, return time, number of haul routes, worksite topography, number of loaders, number of crushers, number of pits, haul route speed limits) modified by coefficients of these independent variables including linear and non-linear regression. Several continuous probability distribution functions, such as normal, Weibull, loglogistic distributions, may be chosen based on the shape and scale of the measured data curves. The fitting technique may determine the coefficients associated with each of the independent variables. These coefficients and the independent variables may describe the model. The independent and dependent variables which may be described by continuous probability distribution functions may be validated through the simulation process against measured data point under the same working conditions.

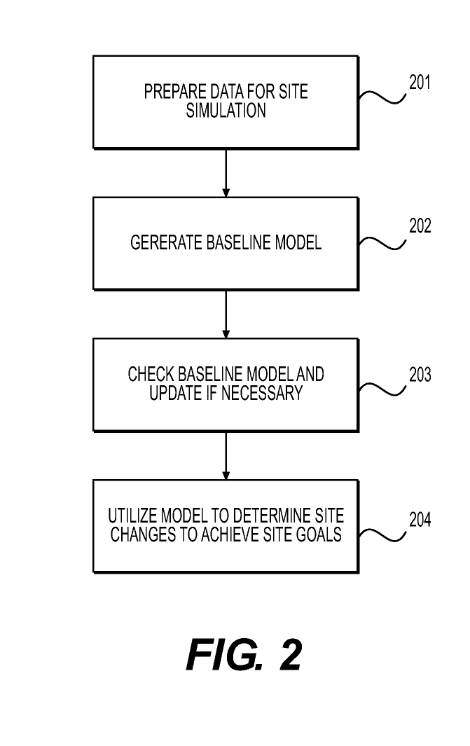

FIG. 2 describes an exemplary algorithm that may be executed by controller 100 to generate a baseline model describing the operations of the worksite using worksite information 101. FIG. 2 is discussed in the following section.

### INDUSTRIAL APPLICABILITY

The disclosed worksite simulation and optimization tool 1 may provide simulation and optimization of operations of a worksite. Simulation tool 1 may allow for optimization of various worksite processes by taking into account unique site characteristics such as the number of haul routes available, machine design performance information of machines operating on the worksite, etc. Operation of simulation tool 1 will now be explained with reference to FIGS. 2-6.

FIG. 2 depicts a flowchart showing an exemplary method for worksite simulation and optimization. In step 201, controller 100 may prepare data for site simulation. Preparing data for site simulation may include obtaining measured data for worksite performance information 111 and obtaining a statistical distribution of the measured data. For example, controller 100 may take several samples of actual load times measured across the worksite and determine a statistical distribution describing the load times. Similarly, controller 100 may take samples of actual haul, dump, and return times measured across the worksite and determine a statistical distribution describing them. Controller 100 may then take samples of the measured worksite production and determine its statistical distribution. As an example of a statistical distribution, controller 100 may determine a probability density function (PDF) of the measured data.

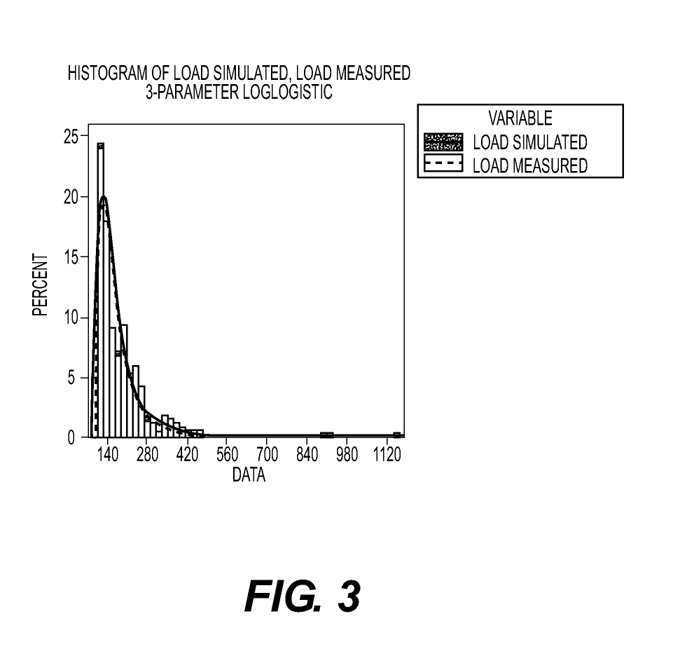

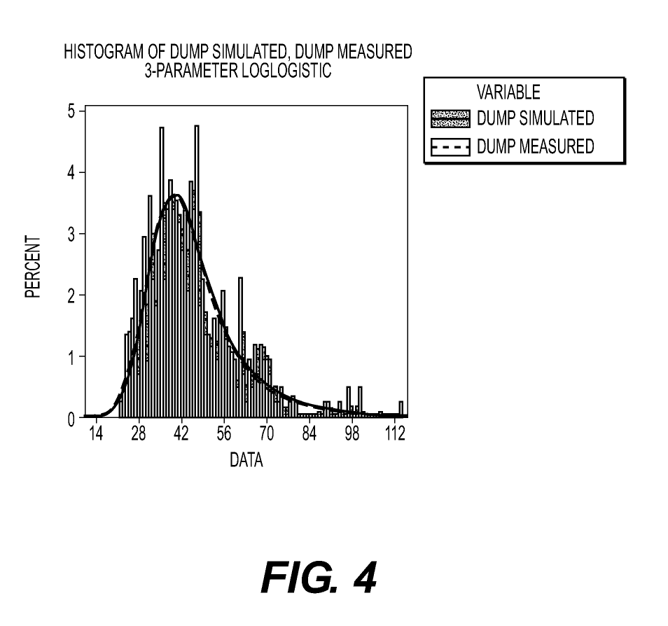

In one embodiment, controller 100 may further divide the load time into load-queue, load-spot, and load-load times. Load-queue may refer to the time that loaders across the worksite wait in a queue to get to a loader. Load-spot may refer to the time loaders across the worksite take to get into a proper loading spot after it is their turn to be loaded. Load-load may refer to the time that loaders across the worksite take to be loaded. Similarly, the dump time may also be divided into dump-queue, dump-spot, and dump-dump. Accordingly, in such an embodiment, controller 110 may determine a statistical distribution of measured data of these sub-components of load and dump times. FIG. 3 illustrates an exemplary distribution for measured load times for a worksite. FIG. 4 illustrates an exemplary distribution for measured dump times for a worksite.

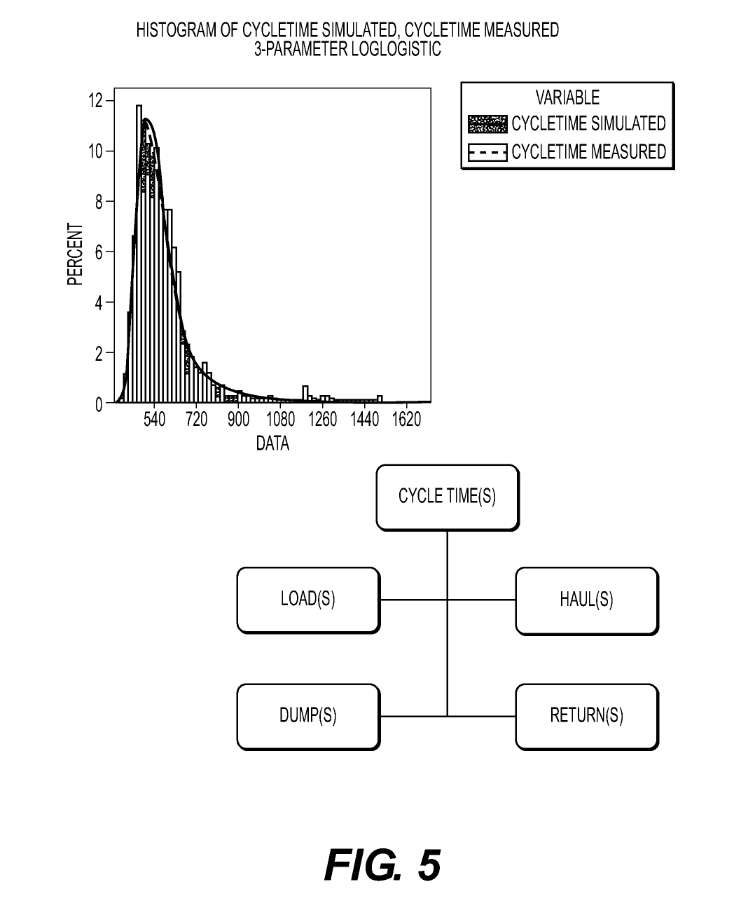

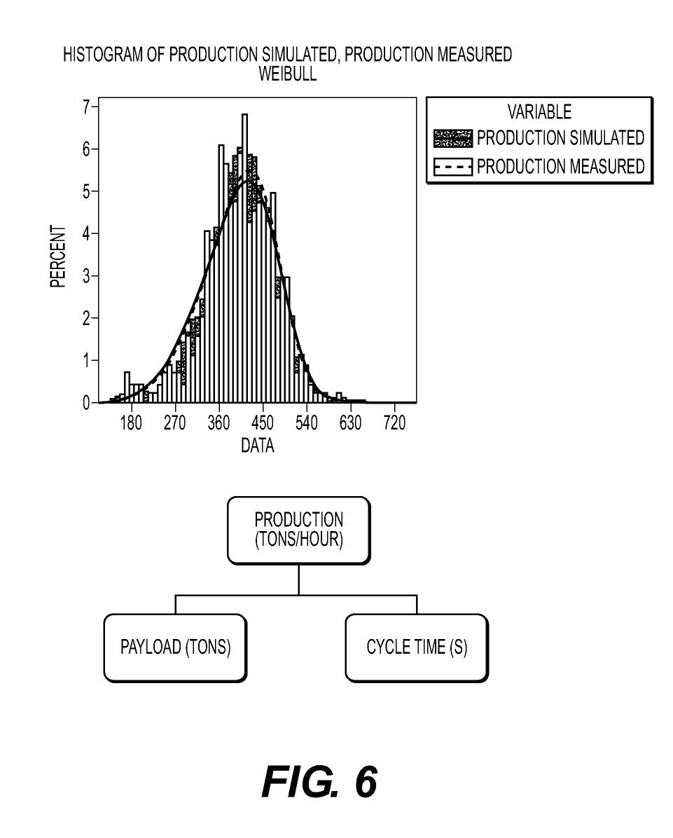

In step 202, controller 100 may generate a baseline model based on the statistical distribution of measured data from step 201, machine design performance information 113, and site layout information 112. Controller 100 may generate the baseline model by using a statistical technique to describe, for example, the worksite production as a function of load time, dump time, haul time, return time, number of haul routes, worksite topography, number of loaders, number of crushers, number of pits, haul route speed limits, etc. The statistical technique may be any fitting technique that fits the measured data such that a dependent variable (e.g., production time) is described as a function of other independent variables (load time, dump time, haul time, return time, number of haul routes, worksite topography, number of loaders, number of crushers, number of pits, haul route speed limits) modified by coefficients of these independent variables. The fitting technique may determine the coefficients associated with each of the independent variables. These coefficients and the independent variables may describe the model. As seen in FIG. 5, another example of a dependent variable may be cycle time, which may be the sum of load time, dump time, haul time, and return time. FIG. 5 illustrates an exemplary distribution of measured data for cycle time. FIG. 6 illustrates an exemplary distribution of measured data for worksite production, which may be described in one instance as the ratio of payload to cycle time.

In step 203, controller 100 may check the baseline model and update the baseline model if necessary. For example, controller 100 may acquire values for the independent variables describing the baseline model. The coefficients of the variables are known from step 202. Exemplarily, controller 100 may obtain a set of measured data for some of the independent variables that are dynamic (e.g., load time, dump time, haul time, return time). For the independent variables that are static (e.g., number of haul routes available, number of crushers, loaders, machine load curve), the values are already known. Controller 100 may input values for all the independent variables and obtain a simulated value for the dependent variable (e.g., cycle time or worksite production). Controller 100 may compare the simulated value with the measured value to determine if the model accurately describes the worksite operations. In the example illustrated in FIGS. 5 and 6, the simulated values of cycle time and worksite production are very similar to the actual measured values. Accordingly, controller 100 may determine that the model is sufficiently accurate and there may be no need to update the model.

Alternatively, if controller 100 determines that the simulated values of the dependent variables are not within a predetermined tolerance of the measured values of the dependent variables, controller 100 may modify the baseline model. For example, controller 100 may iteratively change the coefficients of the various independent variables until the simulated values of the dependent variables are within a predetermined tolerance of the measured values of the dependent variables.

In step 204, controller 100 may utilize the model output from step 203 to determine changes to the worksite to achieve any desired site goals. For example, if one of the site goals 114 is increased productivity, controller 100 could iteratively modify the different independent variables describing the model to determine the necessary changes required for increasing worksite production. As an example, controller 100 may increase the number of haul routes and check whether there is a corresponding increase in the worksite production. Controller 100 may also be able to identify bottlenecks in the worksite operation. For example, controller 100 may determine that a minor change in one of the independent variables results in a significant change in the dependent variable. Controller 100 may identify such an independent variable as a bottleneck.

Simulation tool 1 may allow for optimization of various worksite processes by taking into account unique site characteristics such as the number of haul routes available, machine design performance information of machines operating on the worksite, etc. By incorporating a feedback mechanism where actual measured data refines the simulation model, simulation tool 1 may provide more accurate simulation of the worksite operations.

It will be apparent to those skilled in the art that various modifications and variations can be made to the disclosed worksite simulation and optimization tool. Other embodiments will be apparent to those skilled in the art from consideration of the specification and practice of the disclosed techniques. For example, the steps described need not be performed in the same sequence discussed or with the same degree of separation. Likewise, various steps may be omitted, repeated, or combined. It is intended that the specification and examples be considered as exemplary only, with a true scope being indicated by the following claims and their equivalents.

What is claimed is:

1. A worksite simulation and optimization tool for a worksite, comprising:
one or more memories storing instructions;
a controller configured to execute the instructions to perform operations including:
obtaining measured data for a plurality of worksite processes on the worksite;
performing a statistical analysis of the measured data and outputting a statistical distribution of the measured data;
obtaining machine design performance information for a plurality of machines involved in the plurality of worksite processes;
obtaining site layout information for the worksite; and
generating a model for operation of the worksite based on the statistical distribution of the measured data, the machine design performance information, and the site layout information.

2. The tool of claim 1, wherein generating the model further includes:
generating a baseline model based on the statistical distribution of a first set of measured data, the machine design performance information, and the site layout information; and
updating the baseline model using a second set of measured data, the machine design performance information, and the site layout information.

3. The tool of claim 1, wherein the measured data includes dynamic information and the machine design performance information includes static information.

4. The tool of claim 1, wherein the measured data includes at least one of load time, haul time, dump time, return time, production, and payload.

5. The tool of claim 1, wherein the machine design performance information includes at least one of a machine load curve and a machine power curve.

6. The tool of claim 1, wherein the site layout information includes at least one of number of pits, number of crushers, number of loaders, worksite topography, and number of haul routes.

7. A computer-implemented method for worksite simulation and optimization, the method comprising:
obtaining measured data for a plurality of worksite processes on a worksite;
performing a statistical analysis of the measured data and outputting a statistical distribution of the measured data;
obtaining machine design performance information for a plurality of machines involved in the plurality of worksite processes;
obtaining site layout information for the worksite; and
generating a model for operation of the worksite based on the statistical distribution of the measured data, the machine design performance information, and the site layout information.

8. The computer-implemented method of claim 7, wherein generating the model further includes:
generating a baseline model based on the statistical distribution of a first set of measured data, the machine design performance information, and the site layout information; and
updating the baseline model using a second set of measured data, the machine design performance information, and the site layout information.

9. The computer-implemented method of claim 7, wherein the measured data includes dynamic information and the machine design performance information includes static information.

10. The computer-implemented method of claim 7, wherein the measured data includes at least one of load time, haul time, dump time, return time, production, and payload.

11. The computer-implemented method of claim 7, wherein the machine design performance information includes at least one of a machine load curve and a machine power curve.

12. The computer-implemented method of claim 7, wherein the site layout information includes at least one of number of pits, number of crushers, number of loaders, worksite topography, and number of haul routes.

13. A non-transitory computer-readable storage medium storing instructions that enable a computer to implement a method for worksite simulation and optimization, the method comprising:
obtaining measured data for a plurality of worksite processes on the worksite;
performing a statistical analysis of the measured data and outputting a statistical distribution of the measured data;
obtaining machine design performance information for a plurality of machines involved in the plurality of worksite processes;
obtaining site layout information for the worksite; and
generating a model for operation of the worksite based on the statistical distribution of the measured data, the machine design performance information, and the site layout information.

14. The non-transitory computer-readable storage medium of claim 13, wherein generating the model further includes:
generating a baseline model based on the statistical distribution of a first set of measured data, the machine design performance information, and the site layout information; and
updating the baseline model using a second set of measured data, the machine design performance information, and the site layout information.

15. The non-transitory computer-readable storage medium of claim 13, wherein the measured data includes dynamic information and the machine design performance information includes static information.

16. The non-transitory computer-readable storage medium of claim 13, wherein the measured data includes at least one of load time, haul time, dump time, return time, production, and payload.

17. The non-transitory computer-readable storage medium of claim 13, wherein the machine design performance information includes at least one of a machine load curve and a machine power curve.

18. The non-transitory computer-readable storage medium of claim 13, wherein the site layout information includes at least one of number of pits, number of crushers, number of loaders, worksite topography, and number of haul routes.
